(19) United States
(12) Patent Application Publication
(10) Pub. No.: US 2009/0200916 A1
(43) Pub. Date: Aug. 13, 2009

(54) Cold cathode fluorescent lamp and method of manufacturing the same

(75) Inventor: Hisashi Migita, Mobara (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 12/292,379

(22) Filed: Nov. 18, 2008

(30) Foreign Application Priority Data
Feb. 7, 2008 (JP) 2008-027666

(51) Int. Cl. H01J 63/04; H01J 9/00

(52) U.S. Cl. 313/491; 313/485; 445/58; 445/46

(57) ABSTRACT

There are provided cold cathode fluorescent lamp with high quality and high reliability and method of manufacturing the cold cathode fluorescent lamp, the cold cathode fluorescent lamp making it possible to reduce the amount of a portion on which a sputter phenomenon occurs thereby reducing the discharge start-up time in the cold cathode fluorescent lamp, and to maintain stable discharge for a long period of time thereby improving the dark start-up characteristic as well as high luminance and long life properties. A cold cathode fluorescent lamp has a cesium zirconate film deposited on inner and outer wall surfaces of each of cup electrodes, and a cesium film obtained by activating the cesium zirconate film and deposited on a phosphor film in the vicinity of each of the cup electrodes, thereby changing the electron emission characteristic on the inner wall surface of each of the cup electrodes during lighting to increase a contacting property to the cesium zirconate film, thus generation of the sputtering of the nickel material forming the cup electrodes is reduced.

The present application claims priority from Japanese application JP2008-27666 filed on Feb. 7, 2008, the content of which is hereby incorporated by reference into this application.

### BACKGROUND OF THE INVENTION

The present invention relates to a cold cathode fluorescent lamp applied as a light source of a backlight device for liquid crystal displays such as liquid crystal monitors or liquid crystal television sets, and in particular to an electrode structure of a pair of cup electrodes encapsulated in a translucent glass tube, disposed respectively on both ends thereof so as to face each other, and each having an electrode body coated with a discharge inducing film on inside and outside walls thereof, and a method of manufacturing the electrode structure.

The cold cathode fluorescent lamps are widely used as backlight units for mobile displays for personal computers and stationary displays in home use from the aspect of low profile, light weight, and long life.

The cold cathode fluorescent lamp has a phosphor film formed inside a translucent glass tube, a pair of cold cathodes used inside the glass tube as opposed electrodes, and neon-argon mixed gases (also referred to as inert gases) and traces of mercury encapsulated in the tube, and emits light when a high voltage is applied between the opposed electrodes disposed inside and on both ends of the tube.

In recent years, the cold cathode fluorescent lamps have been expanded in the total length (the tube length), and have been used in many cases as backlight light sources for large screen TVs. In the case in which the cold cathode fluorescent lamp is used in a backlight unit, since the lamp is used in an environment with no ambient light reached, the cold cathode fluorescent lamp used for the backlight unit has an essential requirement of improvement in a dark start-up characteristic in addition to the essential requirements of high luminance and long life.

As an example of the cold cathode fluorescent lamp providing a solution to such a problem, there is disclosed an electrode structure in JP-A-2002-175775. In the electrode structure, a pair of cylindrical electrodes made of zirconium are attached respectively to lead wires disposed inside and on both ends of a tube-like bulb, and cesium oxide is attached only to inside walls of the electrodes. Thus, a hole in the electrode walls and the snake discharge are prevented from occurring by the agency of zirconium with lower work function than nickel and the getter function, and blackening of an inside wall of the lamp is prevented by limiting the attaching area of cesium oxide to the inside walls of the electrodes, thus improving the life and the quality.

### SUMMARY OF THE INVENTION

The cold cathode fluorescent lamp having a pair of cup electrodes made of nickel disposed inside and on both ends of a glass tube so as to face each other emits light when the mercury emits ultraviolet beams in response to reception of secondary electrons emitted from the cup electrodes opposed to each other. On the inside wall side of the cup electrodes, the ionized neon-argon mixed gases collide with the cup electrodes to cause sputtering phenomenon on the inside wall side of the cup electrodes.

However, if a large amount of sputtered portion is generated in the cup electrode, adhesion strength of the welded area between the tip portion of the lead wire for supplying power and the bottom surface of the cup electrode is reduced, resulting in dropping-off of the cup electrode, and therefore, there arises a problem that the reduction of the amount of sputtered portion is absolutely essential.

Further, in the cold cathode fluorescent lamp of this kind, reduction of the discharge start time (the discharge start-up time) is required, and in particular, there arises a problem that a delay is caused in the time required for starting discharge in a dark condition. In general, there is known an effect that the electrons induced by a sputtered film, which is formed by sputtering a part of the electrode made of a nickel material on the inside surface of the glass tube, reduce the discharge start-up time.

In the case of adopting the cup electrodes, by setting the outside diameter (specifically, the outside diameter of the opening section) of the electrode to be smaller than the inside diameter of the glass tube, the sputtering of the electrode material on the inside wall of the glass tube is promoted. However, the sputtering of the electrode material abrades the electrode itself, and therefore, shortens the life of the electrode. Further, even if the sputtered film is formed by an aging process, the resulting reduction of the discharge start-up time is far from sufficient.

It should be noted that the dark start-up means that the cold cathode fluorescent lamp incorporated in the backlight unit and left in the dark (darkness) state for a while takes time before lighting after switching on the lighting device in the dark environment.

Further, in the cold cathode fluorescent lamp of this kind, there arises a problem that the form of discharge is varied by a minute amount of gaseous body generated while lighting to cause flickering lighting (the phenomenon that the discharge shape fluctuates like a snake) in which the form of discharge draws a meandering shape or a spiral shape, thus dramatically degrading the quality of the cold cathode fluorescent lamp. The flickering lighting described above tends to occur notably in accordance with growth in the total length (the tube length) of the cold cathode fluorescent lamp.

Therefore, the present invention has been made for solving the problems in the related art described above, and has an object of making it possible to reduce the amount of generation of the sputtering phenomenon to reduce the discharge start time in the cold cathode fluorescent lamp so as to light rapidly (with discharge start time of shorter than about 1 ms (millisecond) in the dark ambient condition) in response to powering-on, and to maintain stable discharge for a long period of time, thereby improving the dark start-up characteristic together with high luminance and long life properties, thus providing the cold cathode fluorescent lamp with high quality and high reliability and the method of manufacturing the cold cathode fluorescent lamp.

In order for achieving such an object, a cold cathode fluorescent lamp according to the present invention includes a glass tube being translucent and having a rare gas and mercury encapsulated inside, a pair of cup electrodes encapsulated in the glass tube and disposed respectively on both end section of the glass tube so as to be opposed to each other, a pair of power supply wires each having one end connected to respective one of the cup electrodes, and the other end led out of the glass tube, a phosphor layer formed on an inner surface of the glass tube, a cesium compound film deposited on inner and outer wall surfaces of each of the cup electrodes, and a cesium film formed on the phosphor film in the vicinity of each of the cup electrodes by activating the cesium compound film. According to this configuration, the electron emission characteristic on the inner wall surface of each of the cup electrodes during lighting changes to increase a contacting property to the cesium compound film, thereby reducing generation of the sputtering of the cup electrodes, thus the problems of the related art can be solved.

In another cold cathode fluorescent lamp according to the present invention, in addition to the configuration described above, it is preferable that the cesium compound film is a cesium zirconate film.

In another cold cathode fluorescent lamp according to the present invention, in addition to the configuration described above, it is preferable that the cesium compound film is a mixed cesium compound film of a mixture of cesium zirconate and another cesium compound.

In another cold cathode fluorescent lamp according to the present invention, in addition to the configuration described above, it is preferable that the cup electrodes are each formed of a molding of a pure nickel material.

A method of manufacturing a cold cathode fluorescent lamp according to the present invention, the cold cathode fluorescent lamp including a glass tube being translucent and having a rare gas and mercury encapsulated inside, a pair of cup electrodes encapsulated in the glass tube and disposed respectively on both end section of the glass tube so as to be opposed to each other, a pair of power supply wires each having one end connected to respective one of the cup electrodes, and the other end led out of the glass tube, and a phosphor layer formed on an inner surface of the glass tube, the method includes the steps of applying a cesium compound on inner and outer wall surfaces of each of the cup electrodes, and then drying by heating the cesium compound to be attached to the inner and outer wall surfaces of each of the cup electrodes, and activating, after the applying step, the cesium compound to deposit a cesium compound film on the inner and outer wall surfaces of each of the cup electrodes, and to deposit a cesium film on the phosphor film in the vicinity of each of the cup electrodes. By depositing the cesium film, constant generation efficiency can be obtained by controlling the activation condition of the cup electrodes, and further, the extent of an influence by the amount of production of the cesium film on the dark start-up characteristic can quantitatively be figured out, thus the problems of the related art can be solved.

In another method of manufacturing a cold cathode fluorescent lamp according to the present invention, in addition to the configuration of the method described above, it is preferable that the cesium compound is cesium zirconate film.

In another method of manufacturing a cold cathode fluorescent lamp according to the present invention, in addition to the configuration of the method described above, it is preferable that the cesium compound is a mixed cesium compound of a mixture of cesium zirconate and another cesium compound.

It should be noted that the present invention is not limited to the configurations and the method therefor described above, but can variously be modified within the scope or the spirit of the present invention.

According to the present invention, the cesium compound film is attached to the inner and outer wall surfaces of each of the pair of cup electrodes encapsulated in the translucent glass tube provided with the phosphor film formed on the inner wall surface thereof and disposed on the both end sections of the glass tube so as to be opposed to each other, and is formed as the cesium compound film and the cesium film by being activated during the process. Since the work function of zirconium (3.84 eV) and cesium (2.14 eV) is lower than nickel (4.84 eV), which is a composing material of the cup electrodes, the electron emission characteristic on the inner wall surface of each of the cup electrodes is varied during lighting to enhance the contacting property to the cesium compound film. Thus, the amount of the sputtered portion of the nickel material is reduced compared to the case in which the cup electrodes are made only of the nickel material, and therefore, the life improving effect can be obtained.

Further, according to the present invention, by forming a necessary amount of cesium film from the cesium compound film, the measures for the dark start-up characteristic can be taken, thus the quality improvement effect can be obtained. Further, in the case in which the necessary amount of cesium film is not achieved, by mixing another cesium compound with low-temperature degradability thereto, an advantage of making it possible to ensure and figure out the necessary amount.

Further, according to the present invention, since zirconium oxide is produced simultaneously when the cesium compound film is activated into the cesium film, a minute amount of gaseous body generated while lighting is absorbed as the getter function of the zirconium oxide, thus the quality improvement effect of preventing the flicker in discharge from occurring can be obtained.

Further, according to the method of manufacturing a cold cathode fluorescent lamp of the present invention, it is possible to obtain an extremely superior advantage that a high quality cold cathode fluorescent lamp having a high luminance and long life properties, and an improved dark start-up characteristic can easily be manufactured.

Therefore, according to the present invention, it is possible to obtain an extremely superior advantage that a high quality cold cathode fluorescent lamp having a high luminance and long life properties, and an improved dark start-up characteristic can be realized.

### BRIEF DESCRIPTION OF THE DRAWINGS

FIG. 1 is an enlarged cross-sectional view of a substantial part of an overall configuration showing a cold cathode fluorescent lamp according to an embodiment of the present invention.

FIG. 2 is an enlarged cross-sectional view of a substantial part showing a configuration of a peripheral part around an electrode shown in FIG. 1.

### DESCRIPTION OF THE PREFERRED EMBODIMENTS

Hereinafter, a specific embodiment of the invention will be described in detail with reference to the accompanying drawings.

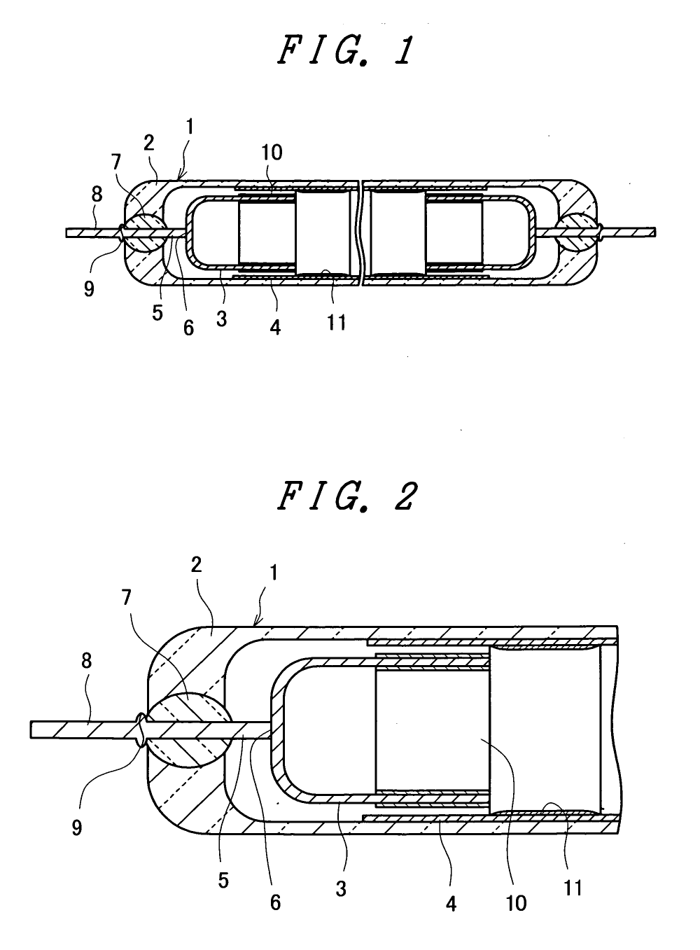

FIG. 1 is a cross-sectional view of a substantial part showing an overall configuration of the cold cathode fluorescent lamp according to an embodiment of the invention, and FIG. 2 is an enlarged cross-sectional view of a substantial part showing a configuration of a peripheral part around an electrode of one end of the cold cathode fluorescent lamp shown in FIG. 1, wherein the high-voltage side of the electrode is shown in FIG. 2, for example.

In FIGS. 1 and 2, the cold cathode fluorescent lamp 1 is configured to have a pair of cup electrodes 3 are encapsulated in a glass tube 2 made of a translucent insulating material disposed respectively on both ends thereof so as to be opposed to each other, and a predetermined amount of neon-argon (Ne—Ar) mixed gases as inert gases and a predetermined amount of mercury encapsulated in the glass tube 2 after evacuated to be a predetermined degree of vacuum. Further, an in sidewall surface of the glass tube 2 is coated with a film-like phosphor film 4.

The cold cathode fluorescent lamp 1 is formed to have a thickness of the both end sections of the glass tube 2 of about 200 μm through 300 μm while the thickness of the main body of the glass tube 2 is, for example, about several hundreds μm. Further, the outside diameter of the glass tube 2 is, for example, about 2.0 mm through 3.0 mm, the inside diameter thereof is about 2.0 through 2.4 mm, and the glass tube 2 is formed to have the total length (the tube length) of about 300 mm through 800 mm in accordance with the size of the display panel.

Further, the pair of cup electrodes 3 are each formed from, for example, a pure nickel material using a press forming process to have a cup-like shape, and are disposed so that the both tips of the opening sections opposed to each other face the main discharge area. On each of the rear ends of the pair of cup electrodes 3, there is electrically connected an inner lead 5 made of a nickel-cobalt-iron alloy having a thermal expansion coefficient approximate to glass bonded with a welded spot 6 formed by heading the inner lead 5 with each of the rear ends and then being welded using, for example, a resistance welding process or a laser welding process.

Further, each of the inner leads 5 is supported by a glass bead 7, and is bonded to the glass tube 2 so as to airtightly seal the inside of the glass tube 2 from the outside thereof. The glass beads 7 are welded to the respective end sections of the glass tube 2, and then the glass tube 2 is seal-cut. The pair of inner leads 5 protruding outwards are electrically connected to respective outer leads 8 made, for example, of a nickel material as power supply wires at welded spots 9 each formed by heading the outer lead 8 to the protrusion of the inner lead 5 and then being welded using, for example, a laser welding process. The pair of outer leads 8 are connected to a power supply circuit (typically an inverter lighting circuit), not shown, and the cup electrodes 3 opposed to each other are supplied with predetermined lighting power therethrough.

Further, the cup electrodes 3 encapsulated in the glass tube 2 so as to be opposed to each other are coated with a film 10 made of a cesium compound such as cesium zirconate on the inner and outer wall surfaces on the opening end side thereof. Further, on the phosphor film 4 in the vicinity of the opening end of each of the cup electrodes 3, there is deposited a cesium film 11 necessary for improving the dark start-up characteristic so as to have a length (width) of about 3 mm.

Here, as the cesium compound, there is used a mixture obtained by combining oxides such as cesium oxide (Cs₂O)+zirconium oxide (ZrO₂). Since metallic cesium having a melting point of about 28.5° C. takes a liquid state at substantial room temperature, and is difficult to handle, cesium is usually used in the form of compound. Further, since a necessary amount of activation energy of the cesium compound can be varied in accordance with the stability thereof, the cesium compound is used according to needs.

A deposition process of the cesium zirconate film 10 and the cesium film 11 described above is as follows. Firstly, prior to manufacturing the cold cathode fluorescent lamp 1, cesium zirconate is previously dissolved in a water solution to be applied to the inside and outside wall surfaces on the opening end side of each of the cup electrodes 3, and is dried by heating using a high-frequency heating process or the like to be attached thereto. Thereafter, in the manufacturing process of the cold cathode fluorescent lamp 1, the cesium zirconate is activated to produce cesium (partially including cesium oxide as an intermediate product).

The cesium and the cesium oxide as the intermediate product thus produced by the activation are migrated onto the phosphor film 4 in the vicinity of the electrodes and attached thereon through the aging process executed thereafter, and thus deposited as the cesium film 11. In the generation of the cesium film 11, constant generation efficiency can be obtained by controlling the activation condition of the cup electrodes 3. Further, on the inner and outer wall surfaces of each of the cup electrodes 3, there remains the cesium zirconate as the cesium zirconate film 10.

Therefore, the process described above can be explained using reaction formulas as follows. Firstly, when the cesium zirconate (Cs₂ZrO₃), which is applied to the inner and outer wall surfaces on the opening end side of each of the cup electrodes 3 and heat-dried to be attached thereto, is activated with application of heat energy E of about 400° C., the following formula is obtained.

Cs₂ZrO₃ (100%)+E→Cs₂O (12.1%)+ZrO₂ (12.1%)+Cs₂ZrO₃ (87.9%)

It should be noted that the numerical values in the parentheses represent compounding ratios.

Here, the activated cesium oxide (Cs₂O) is further activated into metallic cesium (Cs) as the following formula to form the cesium film 11 for improving the dark start-up characteristic.

2Cs₂O+E→4Cs+O₂

Further, the oxygen (O₂) is gasified to be removed.

Further, the activated zirconium oxide (ZrO₂) is further activated into metallic zirconium (Zr) as the following formula with application of the heat energy E, and the oxygen (O₂) is gasified to be removed.

ZrO₂+E→Zr+O₂

Here, the metallic zirconium (Zr) thus activated is used as a gas absorbent material (a getter).

Further, a large proportion of the activated cesium zirconate (Cs₂ZrO₃) remains on the inner and outer wall surfaces of each of the cup electrodes 3 to form the cesium zirconate film 10. The cesium zirconate film 10 improves the dark start-up characteristic, and reduces the cathode drop voltage, thereby making a contribution to energy saving with a ratio of nickel composing the cap electrodes 3.

Further, according to the cold cathode fluorescent lamp 1 thus configured, since the cesium zirconate film 10 is deposited on the inner and outer wall surfaces of each of the cup electrodes 3 made of nickel, even in the condition of the surrounding environment of about 0.1 lux in which the mixed gases of the neon and argon in the cold cathode fluorescent lamp 1 can barely be ionized, the discharge start-up voltage is lowered through the influence of cesium with low work function, and thus the rapid lighting of the cold cathode fluorescent lamp 1 can be made easy.

Here, if an amount of deposited cesium zirconate film 10 thus deposited on the inner and outer wall surfaces of each of the cup electrodes 3 is insufficient, there arises a problem of failing to satisfy the required dark start-up characteristic, on the one hand, and on the other hand, if the amount of deposited cesium zirconate film 10 is too much, there arises a problem that the cesium zirconate film 10 is exfoliated, and remains inside the glass tube 2 as a foreign matter.

Further, the cesium zirconate film 10 does not have a stable characteristic, and apt to migrate inside the glass tube 2, which is kept vacuum. Therefore, the amount of cesium needs to be controlled in order for obtaining the dark start-up characteristic.

Further, the cesium zirconate film 10 produces cesium (partially including cesium oxide as an intermediate product) by activating the cesium zirconate film 10 using a high-frequency heating process after depositing the cesium zirconate film 10 on the inner and outer wall surfaces of each of the cup electrodes 3. Then, the cesium and the cesium oxide as the intermediate product are migrated onto the phosphor film 4 in the vicinity of each of the cup electrodes 3 by an aging process, and are attached thereon thereby forming the cesium film 11. In the generation of the cesium film 11, constant generation efficiency can be obtained by controlling the activation condition of the cup electrodes 3.

Here, depending on the process, there arise some cases in which the predetermined activation conditions are not satisfied. In these cases, the activation conditions can be eased by using a film of a cesium compound having low-temperature degradability such as cesium hydroxide or cesium carbonate mixed to the cesium zirconate film 10. Further, by previously determining an amount of cesium compound having low-temperature degradability, the extent of an influence by the quantity of the activated cesium on the dark start-up characteristic can quantitatively be figured out.

Since the inner wall surface of each of the cup electrodes 3 is used for enhancing the life of the cup electrodes 3 as described above, it is desirable to use the cesium zirconate attached to the outer wall surface of the cup electrode 3 if at all possible. It is possible to take a form easy to execute the high-frequency heating process on the cesium zirconate film 10 existing on the outer wall surface out of the cesium zirconate film 10 attached to the inner and outer wall surfaces of each of the cup electrodes 3.

Further, by activating the cesium zirconate film 10 attached to the inner and outer wall surfaces of each of the cup electrodes 3, zirconium oxide in the cesium zirconate combined with the cesium (partially including cesium oxide as the intermediate product) thus produced is also produced. The zirconium oxide has a stable characteristic with respect to temperature, and constantly exerts the getter effect since the cup electrodes 3 are heated during lighting, thus absorbing the impure gases generated during lighting thereby making it possible to prevent the flickering phenomenon from occurring.

It should be noted that although in the embodiment described above, the case in which the cesium compound is used by being decomposed (activated) in the process is explained, the proportion of the decomposition (activation) in the case in which the heat energy E of about 400° C. is applied to the cesium zirconate (Cs₂ZrO₃) becomes as follows.

Cs₂ZrO₃ (100%)+E→Cs₂O (12.1%)+ZrO₂ (12.1%)+Cs₂ZrO₃ (87.9%)

Further, in contrast, in the case in which cesium oxide (Cs₂O) is added to cesium zirconate (Cs₂ZrO₃) for the purpose of obtaining the dark start-up characteristic, the following proportion is obtained. In the following compounding ratio, for example, the following formula is obtained.

(cesium zirconate (Cs₂ZrO₃)):(cesiumoxide (Cs₂O))=1:0.5

Cs₂ZrO₃ (100%)+Cs₂O (50%)+E→Cs₂O (62.1%)+ZrO₂ (12.1%)+Cs₂ZrO₃ (87.9%)

It should be noted that the reaction of the Cs₂O (62.1%) on the right-hand side in the formula is substantially the same as described above.

What is claimed is:

1. A cold cathode fluorescent lamp comprising:
a glass tube being translucent and having a rare gas and mercury encapsulated inside;
a pair of cup electrodes encapsulated in the glass tube and disposed respectively on both end section of the glass tube so as to be opposed to each other;
a pair of power supply wires each having one end connected to respective one of the cup electrodes, and the other end led out of the glass tube;
a phosphor layer formed on an inner surface of the glass tube;
a cesium compound film deposited on inner and outer wall surfaces of each of the cup electrodes; and
a cesium film formed on the phosphor film in the vicinity of each of the cup electrodes by activating the cesium compound film.

2. The cold cathode fluorescent lamp according to claim 1,
wherein the cesium compound film is a cesium zirconate film.

3. The cold cathode fluorescent lamp according to claim 1,
wherein the cesium compound film is a mixed cesium compound film of a mixture of cesium zirconate and another cesium compound.

4. The cold cathode fluorescent lamp according to claim 1,
wherein the cup electrodes are each formed of a molding of a pure nickel material.

5. A method of manufacturing a cold cathode fluorescent lamp including a glass tube being translucent and having a rare gas and mercury encapsulated inside, a pair of cup electrodes encapsulated in the glass tube and disposed respectively on both end section of the glass tube so as to be opposed to each other, a pair of power supply wires each having one end connected to respective one of the cup electrodes, and the other end led out of the glass tube, and a phosphor layer formed on an inner surface of the glass tube,
comprising the steps of:
applying a cesium compound on inner and outer wall surfaces of each of the cup electrodes, and then drying by heating the cesium compound to be attached to the inner and outer wall surfaces of each of the cup electrodes; and
activating, after the applying step, the cesium compound to deposit a cesium compound film on the inner and outer wall surfaces of each of the cup electrodes, and to deposit a cesium film on the phosphor film in the vicinity of each of the cup electrodes.

6. The method of manufacturing a cold cathode fluorescent lamp according to claim 5,
wherein the cesium compound is cesium zirconate.

7. The method of manufacturing a cold cathode fluorescent lamp according to claim 5,
wherein the cesium compound is a mixed cesium compound of a mixture of cesium zirconate and another cesium compound.

8. The method of manufacturing a cold cathode fluorescent lamp according to claim 5,
wherein the cup electrodes are each formed of a molding of a pure nickel material.

9. The method of manufacturing a cold cathode fluorescent lamp according to claim 5,
wherein the heating is high-frequency heating.
